(19) United States
(12) Patent Application Publication
(10) Pub. No.: US 2013/0337133 A1
(43) Pub. Date: Dec. 19, 2013

(54) LIQUID RECOVERY SYSTEM

(71) Applicant: Step Sciences Limited, Manukau City (NZ)

(72) Inventors: Edwin Robert MEEKE, Pukekohe (NZ); Bruce John TOLLAN, Hamilton (NZ)

(21) Appl. No.: 13/913,914

(22) Filed: Jun. 10, 2013

Related U.S. Application Data
(63) Continuation of application No. PCT/NZ11/00208, filed on Oct. 6, 2011.

(30) Foreign Application Priority Data
Dec. 10, 2010 (NZ) 589834

(51) Int. Cl. A47J 19/00

(52) U.S. Cl. CPC A47J 19/00
USPC 426/478; 99/503

(57) ABSTRACT

A system for recovering liquid from a liquid associated comestibles or liquid associated comestible pieces on a comestible processing line; where the system uses apparatus that comprises or includes:
plural perforate rotatable bowls, each bowl with a pluggable gravity discharge opening for the comestible and each bowl with an opening to allow loading of the bowl with the liquid associated comestible from above,
a collection arrangement for the bowls, or each bowl, whereby liquid centrifugally and/or gravitationally leaving each bowl, at least when each bowl is plug closed and rotating, is recovered, and
a comestible receiving arrangement as part of the processing line for the comestible from each bowl.

The apparatus is operated such that
infeed(s) of the comestible with its associated liquid into the bowls are staggered, bowl by bowl, by at least one infeed arrangement.

The present invention is, in at least one aspect, a liquid recovery system.

The present invention also or alternatively relates to liquid recovery apparatus, methods associated with the use of such apparatus and liquid recovery (particularly but not necessarily so) in respect of a treatment liquid associated with pieces of a comestible (e.g. comestible pieces such as apples, peppers, etc).

The present invention also or alternatively relates to apparatus to separate the liquid and solids, or recover the liquid (if desired) and separately recover (if desired) the solids, of a mixed liquid and solids material.

By way of example the liquid can be a treatment liquid (whether of a serial treatment with one or more different liquids) of solids such as apple pieces, or pieces of another fruit, vegetable or the like item [e.g. herbs] or indeed whole fruit and/or vegetables.

By way of example we include by way of reference a treatment regime disclosed in WO03/017773 of HortResearch. That involves the use of one or more liquids.

In any such system, including our own subsidiary's and our evolution of the HortResearch procedure (www.fresh-appeal.com), there is the prospect of dipping of the product (e.g. apple slices) in a bath of a treatment liquid. The liquid system of a last batch can contain components to be recovered for re-use or different use or to be recovered to avoid a pollutant stream being passed to a discharge into the environment.

In the process discussed below, there is the value of recovering, for example, anti-browning treatment species of a liquid system so as to provide a drier apple piece whilst recovering the valuable content of any excess liquid being removed. This allows downstream a handling of a drier product whilst recovering value.

In the aforementioned patent specifications reference is made to shaking or draining between stages. The present invention sees an advantage in a reliance upon a centrifugal egress of liquid in a spun environment of the solids or fruit pieces.

The present invention also sees an advantage in providing a spin regime of plural spin environments, each environment being able to receive serially, at appropriate stages, the mixed solids/liquid input so as to up throughput. Preferably any such arrangement has a staggering of the stages at which each spin environment is operating.

It is therefore one or more objects of the present invention to provide an alternative (whether a system, apparatus, method or other) to existing liquid recovery regimes or liquid/solids separation regimes in a treatment regime.

It is also a further or alternative object to provide apparatus to receive, spin dry and discharge discrete items.

In an aspect the invention consists in an apparatus to separate the liquid and solids, or recover the liquid and separately recover the solids, of a mixed liquid and solids material (e.g. liquid treated comestible pieces), said apparatus comprising or including

a rotatable bowl having a bottom discharge opening or chute and a top opening to receive the mixed liquid and solids material, the bowl being sufficiently perforate to allow a centrifugal, or centrifugal and gravitational, egress of liquid, but not the solids, from the bowl when the bottom discharge opening or chute is at least substantially plug closed,

a plug or plug assembly (“plug”) able to be moved between conditions whereby the discharge opening or chute (“discharge outlet”) of the bowl will not discharge or will discharge solids (“closed” and “open” conditions respectively),

a drive to rotate directly or indirectly (i) the rotatable bowl or (ii) both the rotatable bowl and at least part of the plug, and

a drain or liquid recovery arrangement to receive liquid egressing from the bowl.

Preferably the plug or part thereof keys to the bowl and a drive to rotate the bowl synchronously also rotates at least part of the plug.

Preferably the rotational axes of the bowl and plug are aligned or are at least substantially vertical.

Preferably a feed device can load the mixed liquid and solids material into the bowl once the plug is closing the discharge outlet.

Preferably there is a control system whereby the following operational sequence applies:
the solids/liquid mix is top loaded into the bowl after its plug closure and optionally whilst slowly spinning,
the plug closed bowl is spun up to fling the liquid from the bowl retained solids
the bowl is slowed,
the unplugged bowl when slowly spinning and/or the unplugged bowl when stopped (e.g. abruptly) dumps the solids through the outlet,

Optionally the dumping of solids can be assisted by an hygienic air flow.

Preferably the bowl is substantially cylindrical above a substantially frustoconical zone to the outlet [preferably a conduit in part used to rotatably mount the rotatably drivable bowl].

In another aspect the invention is a liquid recovery plant (e.g. suitable for liquid treated comestible pieces) comprising or including

a bank or array of apparatus of the present invention as previously defined as aforesaid, and

a feed device able serially to feed into each bowl, when each bowl is at least substantially empty of solids and when closed by its plug, a quantum of the mixed liquid and solids material.

Preferably the feed device is a rotatable hopper with a chute outlet (e.g. an asymmetric frustum) set to discharge away from the hopper's rotational axis thereby to be able to index/register to each of a plurality of bowls disposed about that rotational axis.

Preferably the hopper has a stipple profiled inner surface (e.g. of 6WL stainless steel) to reduce solids retention.

Preferably the control is such that, with respect to each pluggable bowl, there is
the solids/liquid mix is top loaded into the bowl after its plug closure and optionally whilst slowly spinning,
the plug closed bowl is spun up to fling the liquid from the bowl retained solids
the bowl is slowed,
the unplugged bowl when slowly spinning and/or the unplugged bowl stopped (e.g. abruptly) dumps the solids through the outlet, possibly air assisted.

In a further aspect the present invention is the use of a centrifugal, or centrifugal and gravitational, separation of a comestible piece treatment liquid from the comestible pieces, with recovery of at least some of such separated liquid and harvesting of the drier comestible pieces.

In another aspect the invention is a system for recovering a liquid for recycle from a comestible or comestible pieces (“comestible”) processing line or lines, the system being reliant on

plural perforate rotatable bowls, each bowl with an opening to allow loading of the bowl with the comestible from above, and each bowl with a pluggable discharge opening for the comestible,

at least one collection arrangement for the bowls whereby liquid centrifugally and/or gravitationally leaving each bowl is recovered, and

at least one comestible receiving arrangement for the comestible from the bowls;

the apparatus being operated such that infeeds of the comestible with its liquid into the bowls are staggered by an infeed arrangement and the outfeed of the comestible from the plural bowls is staggered thereby to provide an at least receipt of the comestible by the at least one collection arrangement.

Preferably the bowl has recessed zones having outlets for the liquid outflow.

Preferably these zones are outwardly form dimples with a slit of some form (preferably a cruciform slit or a starburst slit).

The dimpled slit forms can be dimpled when a precursor sheet of stainless steel preferably after laser or water jet cutting the opening.

By way of example only, the plant, apparatus, methods, procedures of the present invention can be used with any liquid ingredient recovery process or any liquid pollutant recovery process where the liquid is associated with solids to be cleared of at least some of that liquid.

By way of an example we wish to refer to a comestible treatment regime (e.g. not just restricted to apple pieces) that includes [for example as disclosed in New Zealand patent 513899/513936 or WO03/017773 of HortResearch]. Such a system [whether or not it uses a UV irradiation using apparatus as in New Zealand patents 518658 and 542509] does associate the comestible pieces (as solids) with at least one liquid system (“liquid”).

The treatment regime can include in any suitable sequence [not necessarily the sequence as listed]

(a) UV irradiation

(b) sub-lethal heating and/or

(c) an anti-browning treatment.

It may even have had precursor steps.

If, for example, a step is the anti-browning treatment with an aqueous presence of an ascorbate [e.g. calcium ascorbate alone] and/or ascorbic acid and/or soluble and compatible salt(s) (e.g. calcium salts), recovery of such calcium and/or ascorbate species can quickly recover the cost of plant to clear the treated comestible pieces of any excess presence of such species when much of the water, as the species carrier, is removed from the solids product stream being recovered (by dumping from the bowl) onto a conveyor or chute for downstream handling [e.g. cooling, packing, etc].

The present invention also relates in apparatus, whether the assembly, subassembly or components of a system, substantially as herein described with reference to any one or more of the accompanying drawings.

In yet a further aspect the invention consists in a method of separating a liquid from solids which involves a temporarily plugged bowl able to spin.

Preferably the arrangement is substantially as herein described with reference to any one or more of the accompanying drawings.

In another aspect the invention is a system for recovering liquid from a liquid associated comestibles or liquid associated comestible pieces (“comestible”) on a comestible processing line;

wherein the system uses apparatus that comprises or includes:

plural perforate rotatable bowls, each bowl with a pluggable gravity discharge opening for the comestible and each bowl with an opening to allow loading of the bowl with the liquid associated comestible from above,

a collection arrangement for the bowls, or each bowl, whereby liquid centrifugally and/or gravitationally leaving each bowl, at least when each bowl is plug closed and rotating, is recovered, and

a comestible receiving arrangement as part of the processing line for the comestible from each bowl;

and wherein the apparatus is operated such that

infeed(s) of the comestible with its associated liquid into the bowls are staggered, bowl by bowl, by at least one infeed arrangement,

the outfeed(s) of the comestible from the plural bowls is staggered, bowl to bowl, thereby to provide a sequenced receipt of the comestible by the comestible receiving arrangement, and

each bowl with its plugged gravity discharge opening and its comestible and any associated liquid content is spun up from its comestible and associated liquid receiving stationary, or rotating, condition and each bowl is spun down to a slowly rotating and/or non rotating discharging condition.

Optionally the infeed arrangement is of a single conveyer dispensing comestible and liquid sequentially in the bowls reliant upon a sequentially presented chute to the bowls.

Optionally plural conveyors provide the infeed, one conveyor to each bowl.

Optionally circulating conveyor serially infeeds to each bowl.

Optionally a carousel of the bowls serially presents each bowl to an infeed conveyor.

Preferably each bowl and its plug is spinning at sub optimal rotational speeds for the centrifugal and gravitational separation of the liquid from the comestible and in the bowl.

The invention is also a method of recovering at least some liquid from a liquid associated comestible or liquid associated comestible pieces (“comestible”), said method comprising

sequentially loading plural perforate rotatable bowls, each bowl with a pluggable discharge opening for gravity discharge when unplugged of the comestible, and each bowl with an opening to allow loading of the bowl with the liquid associated comestible from above, and

rotating each bowl to cast liquid from within the bowl to at least one zone from whence the liquid is recoverable prior to unplugging the respective bowl before a discharge of the comestible, and recovering the liquid from the at least one zone.

As used herein “solids” includes one or more types of solid material. “Solid” preferably refers to a comestible [e.g. a comestible piece of a treated or part treated fruit or vegetable]. Typical examples include for instance fruits (e.g. apples, berries, pears, peppers, cabbages, lettuces, turnips, carrots, beetroot, potatoes, onions, etc).

As used herein the term “(s)” following a noun means one or both of the singular or plural forms.

As used herein the term “and/or” means “and” or “or”. In some circumstances it can mean both.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

A preferred form of the present invention will now be described with reference to the accompany drawings in which

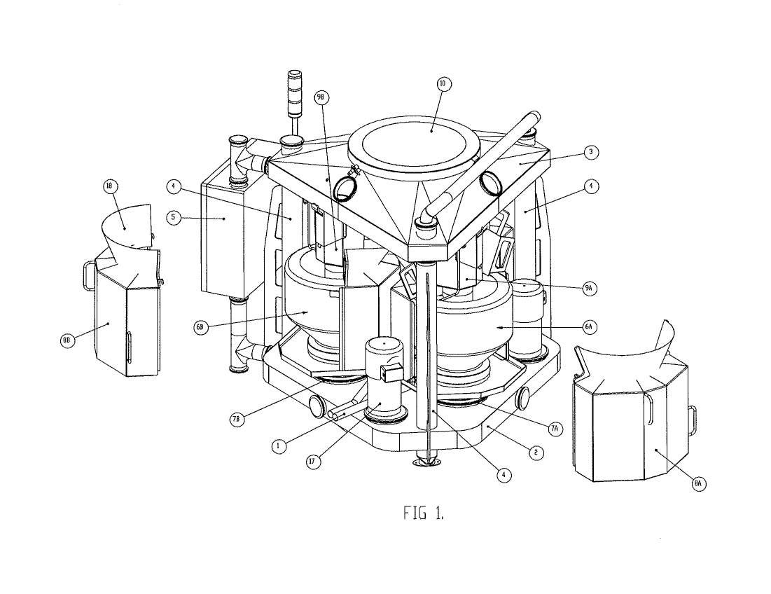

FIG. 1 shows from above a tower arrangement supporting a three bowl embodiment of the apparatus,

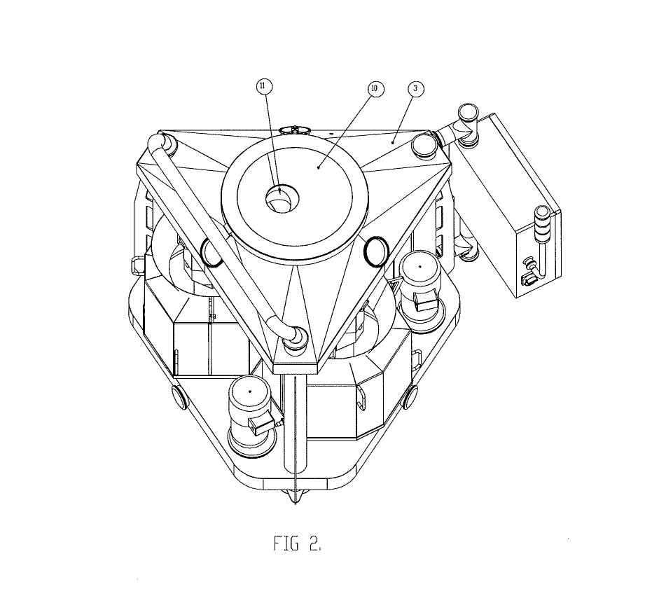

FIG. 2 is a higher view from above of the apparatus of FIG. 1 showing the asymmetry of the rotatable hopper drivable from an upstand drive assembly from the lower platform and supported over the top platform from which the plugging region of each of three plug assemblies can descend from an open position for the bottom of its respective bowl to a closed position of the respective bowl,

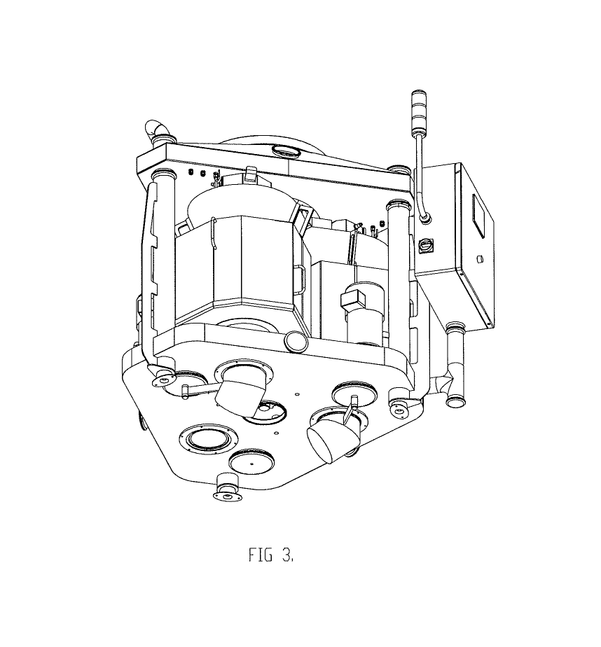

FIG. 3 is a view from below of the apparatus as shown in FIGS. 1 and 2 showing how a lower platform can provide a location for three motor assemblies each able with a drive (cogged or pullied) [a sprocket drive through an endless belt preferably being used—the belts not being shown] to rotate its respective bowl by rotating a drivable member (sprocket, cog or pulley) of downward part thereof, notwithstanding the chute from each bowl being used both as part of the rotational mounting of and for driving its bowl as well as the outlet, still allowing a dump download when unplugged down onto a conveyor for the solids stream (not shown),

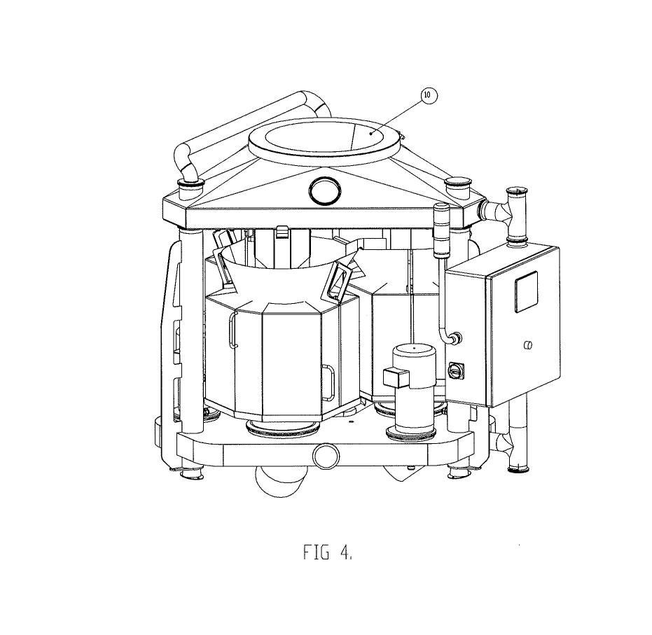

FIG. 4 is a view of the apparatus of FIGS. 1 to 3 showing the lower and upper platforms substantially as if transparent so as to show the nature of some of the mounting arrangements,

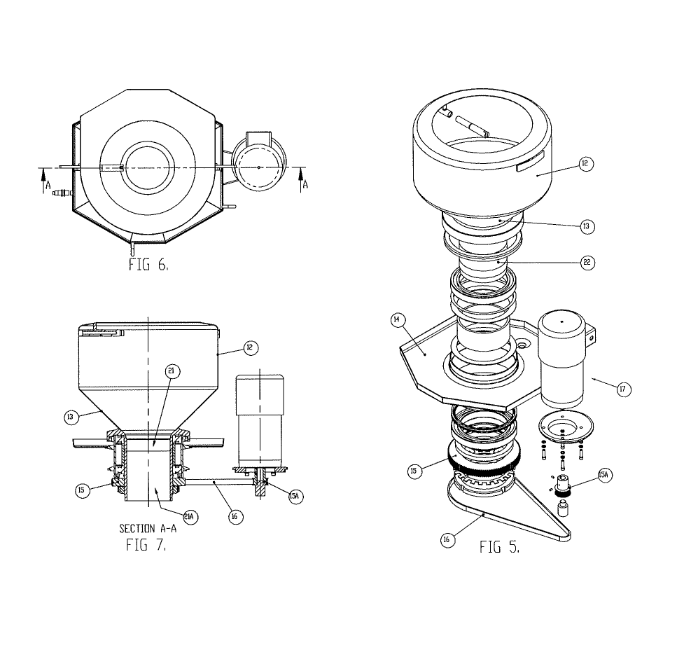

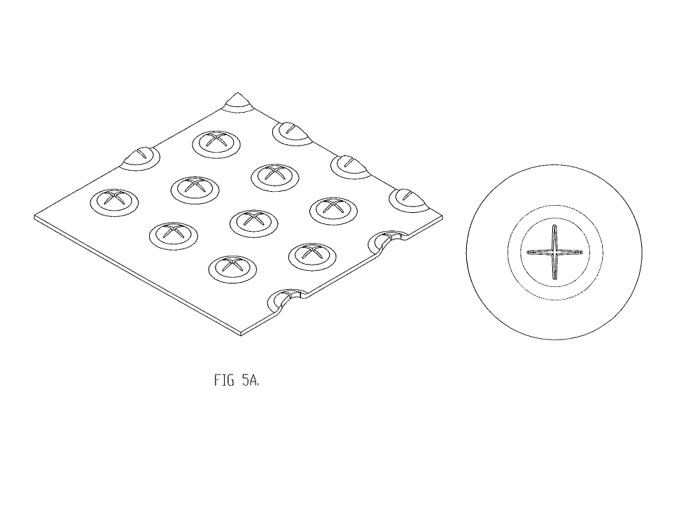

FIG. 5 is an exploded view of a preferred bowl assembly, there being seen that each motor has a sprocket to belt drive to its sprocketed respective bowl assembly, the bowl not showing the outwardly dimpled and distorting cruciform slits to provide dimpled outlets that are preferred, FIG. 5A instead showing that feature,

FIG. 6 is a plan view of an assembly made from the exploded components of FIG. 5,

FIG. 7 is the section A-A of the apparatus of FIG. 6,

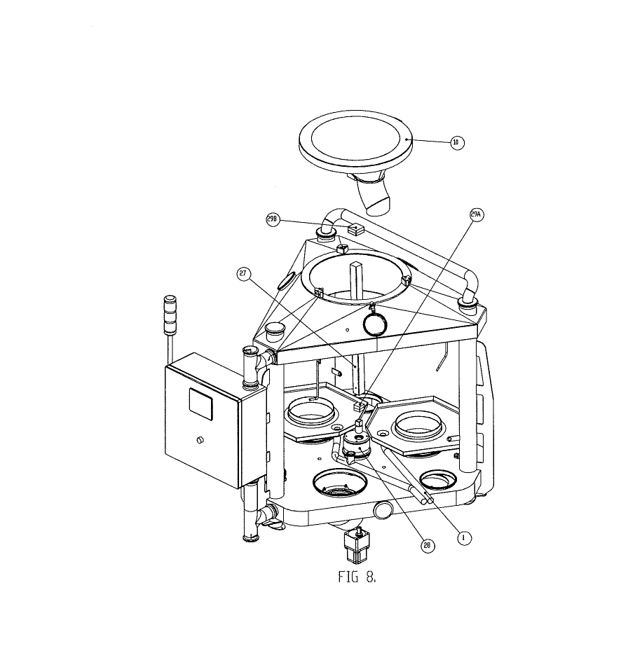

FIG. 8 is an exploded view of the upper and lower platforms and at least some of the components to fit thereto, with exploded drive assembly for the intake providing asymmetric but rotatable hopper,

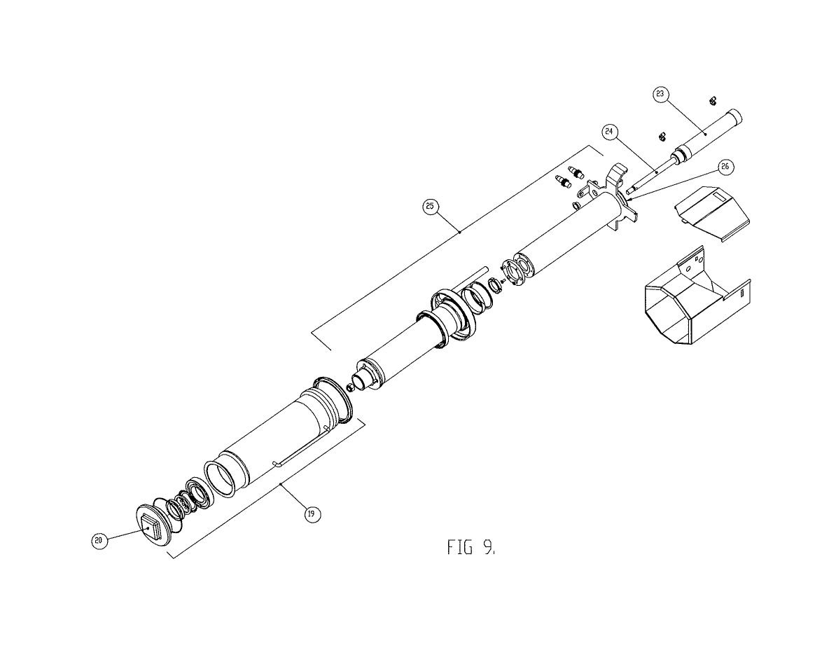

FIG. 9 shows an exploded view of a preferred plug assembly of the present invention,

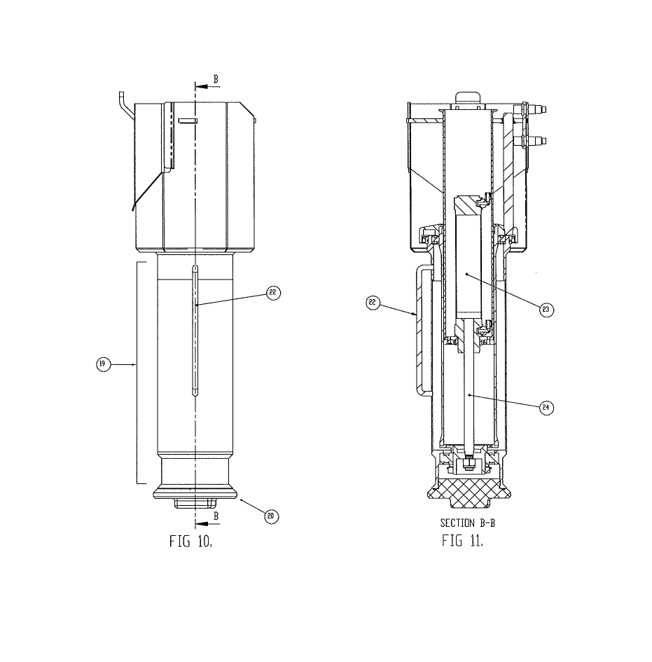

FIG. 10 is a side elevation of a preferred plug of the present invention, and

FIG. 11 is the section B-B with respect to FIG. 10,

In preferred embodiments of the present invention, the apparatus for hygienic purposes, as well as for appearance, is where appropriate preferably formed from a suitable stainless steel.

Preferably the arrangement is substantially as shown in FIGS. 1 to 5 with a tower stand or frame arrangement (not shown) supporting a lower platform 2 above which a second platform 3 is supported by upstanding members 4.

From the platforms 2 and 3 a control panel 5 can be provided.

Shown in the drawings as 6A, 6B and 6C (6C not shown) are three assemblies adapted to rotate from their respective mount 7A, 7B and 7C (7C not shown).

Surrounding each bowl is a quickly removable housing component 8A, 8B and 8C (8C not shown) respectively for each of the assemblies.

Shown above each of the assemblies 6A to 6C is a respective plug assembly 9A, 9B and 9C (9C not shown) respectively.

Shown supported rotatably from the upper platform and the upstand from the lower platform is an asymmetric hopper 10 having a discharge outlet 11 able, upon rotation, of migrating the opening so that it comes into register or indexes serially, or as required by the controller, and under the control of its rotational drive, over the open annulus about each plug assembly within each bowl.

As can be seen in FIG. 5, each bowl is perforate over at least the cylindrical zone 12 (and optionally also some or all of the frustoconical zone 13) so as to allow the egress of liquid, when it spins on its mounts (e.g. if the bowl is about from 0.4 m to about 1 m in diameter from say 100 to 400 RPM—more preferably 200 to 300 RPM) so that liquid flung outwardly against the respective housing. As the housing each of 8A, 8B and 8C (8C not shown) respectively, and their complement as a housing assembly, do ensure capture of liquid down into the pan 14 from whence (not shown) there is a drain feed under gravity to a collection apparatus 1. Preferably several manifolds or channels collect from each of the three pans 14 to collect to a single zone.

FIG. 5A shows a preferred laser cut cross (e.g. of about 0.2 mm to 1 mm width) that splays as a consequence of outward dimpling and subsequent bowl formation from the, by then, perforate sheet.

Shown in the exploded view is a drive sprocket 15 for a belt (16) from the sprocket 15A of a motor assembly 17.

Shown forming part of the housing arrangement of each rotatable bowl is an outwardly flared intake guide member 18 for each housing assembly (whether incorporating 8A, 8B and 8C) ensuring the capture into the bowl of all solids that are dropped via the outlet 11 from the hopper 10 when in register over the annulus between the plug assembly and bowl.

The plug assemblies 9A to 9C respectively can best be understood by reference to FIGS. 9 to 11. Here there is seen a component region 19 having a region 20 adapted to drop into and close its respective bowl by occluding the open bottom at region 21. Region 21 is above the further downward extension 21A (in the form of a conduit) that assists in the mounting arrangement. That extension 21A nonetheless provides a passageway downwardly for discharge as well as a mount for a driven sprocket.

Shown in FIGS. 9 to 11 is the upper part of the plug assembly that supports the lower component 19 to be subject to pneumatic or linear motor movement upwardly and downwardly under the control of a computerised or microprocessor control.

The component 19 is free to rotate relative to the support it receives from above.

Any suitable mounting of this kind is appropriate from the platform 3 including that that can be discerned from the exploded view where plate 26 connects. There can be a series of telescopic actions to emphasise movement. A pneumatic cylinder or linear motor 23 can be used to control the movement of the slider 25 that carries in part the component 19 and its separate pneumatic drive.

Persons skilled in the art with reference to the drawings 9 to 11 will see how a pneumatic cylinder 23 and its piston 24 has the ability to raise and lower, from the zone 21, the member 19.

As can be seen the component 19 includes a keyable outstand 22 which is adapted to key into the bowl or the support of the bowl so that it rotates in unison with the bowl.

The appropriate keying arrangement for the bowl provided by a region of the bowl is preferably such that the contraction and expansion movement upwardly and downwardly respectively of the telescopic assembly remains keyed between the open and closed conditions.

Also shown in the drawings in FIG. 8 is an upstand 27 able to support the rotation about the rotational axis of the hopper 10. This can be driven by a drive (28) able to increment the rotation to positions in register respectively with each of the annular deposition zones between the respective plug/bowl combinations in such annulus. This involves a swivel indexing drive motor, gearbox and a universal couplings 29A and 29B.

In operation the through put can be nearly continuous. As one bowl empties, one can be loading and the other can beat full spin speed. The discharge from a fully spun load in a bowl is assisted by the bowl abruptly being halted in its rotation from a lesser speed than the fully ramped up spin speed. Hygienically filtered air can also be used to assist evacuation by air blow.

An abrupt stop leads to a sudden slump drop of the comestible pieces yet none of the speeds at intake or near discharge are harmful to the product. And nor the full spin speed.

A complete cycle can be over a period as little as, say, 20 seconds to 2 minutes. For example over a period of, say, 10 seconds the bowl can be spun up to about 50RPM as it is loading, then spun up to from 250 to 300 RPM for about 15 seconds, and finally spun down as it is unplugged and finally, for example over about 2 seconds, brought from a much slower speed to an abrupt halt.

Options and/or features to note include:
Drive train sealed in housing for hygienic purposes.
Falling height kept to minimum to minimise comestible damage.
Individual centrifuges could be arranged in linear row, fed by a common recirculating conveyor with feed gate mechanisms.
Potential of adding spraying system for automatic cleaning.
Covers 8A to 8C are removable for cleaning safety devices prevent rotation of uncovered bowls.
Linear motors could be used instead of pneumatic cylinders.
Servo/Stepper motor and gearbox (preferred) can be substituted by a pneumatic indexing module.
To facilitate a larger discharge opening in base of bowl, the bearing arrangement could be peripheral or planetary, with bowl spinning between three bearings, rather than current axial bearing arrangement.

1. An apparatus to separate comestible solids from liquid, or recover the liquid and separately recover the comestible solids, from a liquid associated comestible mixture, said apparatus comprising or including
a rotatable bowl having a bottom discharge opening or chute and a top opening to receive the liquid associated comestibles, the bowl being sufficiently perforate to allow a centrifugal, or centrifugal and gravitational, egress of liquid, but not the comestible solids, from the bowl when the bottom discharge opening or chute is at least substantially plug closed,
a plug supported from above by a plug assembly and able to be moved between conditions whereby the discharge opening or chute (“discharge outlet”) of the bowl will not discharge or will discharge comestible solids (“closed” and “open” conditions respectively),
a drive to directly or indirectly rotate the rotatable bowl or both the rotatable bowl and at least part of the plug, and
a drain or liquid recovery arrangement to receive liquid egressing from the bowl.

2. The apparatus of claim 1 wherein the plug or part thereof keys to the bowl and a drive to rotate the bowl synchronously also rotates at least part of the plug.

3. The apparatus of claim 1 the rotational axes of the bowl and at least part of plug are aligned or are at least substantially vertical.

4. The apparatus of claim 1 wherein a feed device is provided that can load the liquid associated comestibles into the bowl once the plug has closed or is closing the discharge outlet.

5. The apparatus of claim 1 wherein there is a control system whereby the following operational sequence applies:
(a) the liquid associated comestible mixture is top loaded into the bowl after its plug closure and optionally whilst slowly spinning,
(b) the plug closed bowl is spun up to fling the liquid from the bowl retained comestible solids
(c) the bowl is slowed, and
(d) the unplugged bowl when slowly spinning and/or the unplugged bowl when stopped (e.g. abruptly) dumps the comestible solids through the outlet.

6. The apparatus of claim 5 wherein the dumping of the comestible solids is assisted by an air flow.

7. The apparatus of claim 1 wherein the bowl is substantially cylindrical above a substantially frustoconical zone to the outlet.

8. The apparatus of claim 7 wherein the outlet is into a conduit in part used to rotatably mount the rotatably drivable bowl.

9. The apparatus of claim 1 any of wherein the supporting plug assembly is substantially within the bowl.

10. The apparatus of claim 1 wherein the comestible solids are discharged onto a conveyor positioned substantially directly beneath the outlet.

11. (canceled)

12. A liquid recovery plant suitable for separating comestible solids from liquid, and for recovering the liquid and separately recovering the comestible solids from a liquid associated comestible mixture, the plant comprising or including
a bank or array of apparatus of claim 1 and
a feed device able serially to feed into each bowl, when each bowl is at least substantially empty of solids and when closed by its plug, a quantum of the liquid associated comestibles.

13. The plant of claim 12 wherein the feed device is or includes a rotatable hopper with a chute outlet set to discharge away from the hopper's rotational axis thereby to be able to index/register to each of a plurality of bowls disposed about that rotational axis.

14. The plant of claim 13 wherein the rotatable hopper with a chute outlet is an asymmetric frustum.

15. The plant of claim 13 wherein the hopper has a stipple profiled inner surface to reduce solids retention.

16. The plant of claim 12 wherein the control is such that, with respect to each pluggable bowl, there is
(i) the liquid associated comestibles is top loaded into the bowl after its plug closure and optionally whilst slowly spinning,
(ii) the plug closed bowl is spun up to fling the liquid from the bowl retained comestible solids,
(iii)the bowl is slowed,
(iv) the unplugged bowl when slowly spinning and/or the unplugged bowl stopped (e.g. abruptly) dumps the comestible solids through the outlet.

17. The plant of claim 16 wherein the dumping of the comestible solids through the outlet is assisted by an airflow.

18. (canceled)

19. The plant of claim 12 when each bowl has recessed zones having outlets for the liquid outflow.

20. The plant of claim 19 wherein said recessed zones are outwardly formed dimples with a slit of some form.

21. The plant of claim 20 wherein the slit is a cruciform slit or a starburst slit.

22. A system for recovering liquid from a liquid associated comestibles or liquid associated comestible pieces (“comestible”) on a comestible processing line;
wherein the system uses apparatus that comprises or includes:
plural perforate rotatable bowls, each bowl with a pluggable gravity discharge opening for the comestible and each bowl with an opening to allow loading of the bowl with the liquid associated comestible from above,
a collection arrangement for the bowls, or each bowl, whereby liquid centrifugally and/or gravitationally leaving each bowl, at least when each bowl is plug closed and rotating, is recovered,
a comestible receiving arrangement as part of the processing line for the comestible from each bowl,
and each plug being supported from above by a plug assembly positioned substantially within each bowl;
and wherein the apparatus is operated such that
infeed(s) of the comestible with its associated liquid into the bowls are staggered, bowl by bowl, by at least one infeed arrangement,
the outfeed(s) of the comestible from the plural bowls is staggered, bowl to bowl, thereby to provide a sequenced receipt of the comestible by the comestible receiving arrangement, and
each bowl with its plugged gravity discharge opening and its comestible and any associated liquid content is spun up from its comestible and associated liquid receiving stationary, or rotating, condition and each bowl is spun down to a slowly rotating and/or non rotating discharging condition.

23. The system as claimed in claim 22 wherein the infeed arrangement is of a single conveyer dispensing comestible and liquid sequentially in the bowls reliant upon a sequentially presented chute to the bowls.

24. The system as claimed in claim 22 wherein plural conveyors provide the infeed, one conveyor to each bowl.

25. The system of claim 22 wherein a circulating conveyor serially infeeds to each bowl.

26. The system of claim 22 wherein a carousel of the bowls serially presents each bowl to an infeed conveyor.

27. The system of claim 22 wherein the device for loading the bowls is or includes a rotatable hopper with a chute outlet set to discharge away from the hopper's rotational axis thereby to be able to index/register to each of a plurality of bowls disposed about that rotational axis.

28. The system as claimed in claim 22 wherein each bowl and its plug is spinning at sub optimal rotational speeds for the centrifugal and gravitational separation of the liquid from the comestible and in the bowl.

29. A method of recovering at least some liquid from a liquid associated comestible, said method comprising
sequentially loading plural perforate rotatable bowls, each bowl with a pluggable discharge opening for gravity discharge when unplugged of the comestible, each bowl with an opening to allow loading of the bowl with the liquid associated comestible from above, and each plug being supported from above by a plug assembly located substantially within each bowl,
rotating each bowl to cast liquid from within the bowl to at least one zone from whence the liquid is recoverable prior to unplugging the respective bowl discharge of the comestible, and recovering the liquid from the at least one zone.
